(19) United States
(12) Patent Application Publication
(10) Pub. No.: US 2021/0135519 A1
(43) Pub. Date: May 6, 2021

(54) ELECTRIC MOTOR

(71) Applicant: Mahle International GmbH, Stuttgart (DE)

(72) Inventors: Sebastjan Masera, Rence (SI); Peter Sever, Murska Sobota (SI); Robert Vodopivec, Rence (SI)

(21) Appl. No.: 16/492,102

(22) PCT Filed: Feb. 27, 2018
(86) PCT No.: PCT/EP2018/054797

§ 371 Date: Sep. 6, 2019

(30) Foreign Application Priority Data
Mar. 7, 2017 (DE) 10 2017 203 736.9

(51) Int. Cl. H02K 1/27; H02K 1/28; H02K 7/08; H02K 21/14; H02K 15/03; F04D 13/06

(52) U.S. Cl. CPC H02K 1/278; H02K 1/28; F04D 13/06; H02K 21/14; H02K 15/03; H02K 7/083

(57) ABSTRACT

An electric motor, e.g., for a motor vehicle, includes an internal rotor arranged rotatably supported about a rotation axis relative to an external stator. The internal rotor includes a pot-shaped receiving sleeve arranged around a rotor shaft and an armature unit received in the rotor receiving sleeve. The armature unit includes a multiple-layered metal sheet assembly and a plurality of permanent magnets. The plurality of permanent magnets are arranged with spacing from each other in a peripheral direction at a radial outer side of the metal sheet assembly. The sheet metal assembly includes at least one retention device disposed integrally thereon in an intermediate space between adjacent permanent magnets, structured and arranged to reduce slippage of the permanent magnets in the peripheral direction.

### CROSS-REFERENCE TO RELATED APPLICATIONS

This application claims priority to PCT/EP2018/054797 filed on Feb. 27, 2018, and to German Application DE 10 2017 203 736.9 filed on Mar. 7, 2017, the contents of each of which are hereby incorporated by reference in their entirety.

### TECHNICAL FIELD

The present invention relates to an electric motor, in particular for a motor vehicle. The invention further relates to an electric machine or an electric fluid pump which has such an electric motor. Finally, the invention relates to a method for producing such an electric motor.

### BACKGROUND

There are known in the prior art a large number of different electric motors which are constructed as so-called wet runners and which are at times in direct contact with a fluid.

DE 195 25 704 C1 discloses an enclosed rotor of the cage rotor construction type for an asynchronous motor as a wet running motor which comprises a corrosion-free drive shaft, a metal sheet assembly mounted thereon with electrically short-circuited short-circuit rods and a fluid-sealing protective casing which surrounds the metal sheet assembly and which comprises a peripheral portion and two end plates each having a central hole. In order to improve the fluid-tightness of the protective casing with respect to the drive shaft, there is constructed between the drive shaft and the two end plates, which surround the shaft and which are preferably constructed as short-circuit plates, an annular gap in which there is arranged a sealing ring member of non-metallic resilient material which, on the one hand, is located in a fluid-tight manner on the drive shaft and, on the other hand, abuts the associated end plate.

WO 2009/037019 A1 discloses a pump rotor for a canned motor pump which has a one-piece base member having a running wheel base plate and a rotor receiving bush, wherein a rotor unit having rotor magnets is arranged on the rotor receiving bush.

WO 2013/053537 A2 discloses a rotor or stator of an electric machine comprising: a rotor axis which extends in an axial direction, a base member which is arranged concentrically around the rotor axis, at least one permanent magnet which is arranged in a recess of the base member and a clamping means which fixes the permanent magnet in the recess. At opposite sides of the recess in the base member there are provided recesses in which the clamping means is arranged. There is further known a method for mounting a permanent magnet in a previously described rotor or stator and in a motor which has a previously described rotor or stator.

WO 02/39565 A1 discloses an armature for an electric machine, which armature comprises at least one rotor shaft and at least two sheet laminates, wherein at least one sheet laminate has at least one closed pocket and at least one magnet is arranged in the closed pocket. The individual sheet laminates are arranged so as to be rotated relative to each other about the rotor shaft so that, for example, the magnets are alternately arranged in a closed pocket or are exposed. As a result of the bundling of the individual sheet laminates, the magnets are securely retained, on the one hand, and, on the other hand, they are partially freely open so that losses of the magnetic flux are reduced.

From DE 10 2005 048 731 A1, DE 10 2006 036 392 A1, DE 10 2010 021 595 A1, DE 10 2010 044 453 A1 and WO 2011/048581 A2 rotors for electric motors are known, in which permanent magnets are fastened to the laminated core by means of retention devices, which engage radially in gaps, which are formed in the peripheral direction between adjacent permanent magnets. The retention devices are each designed as a one-piece holding structure which has two outer contours facing away from each other in the peripheral direction on a continuous, continuous basic body, which interact with the adjacent permanent magnet to fix it to the metal sheet assembly.

The problem addressed by the present invention is to provide, for an electric motor of the type described above or for a combination provided therewith, an improved embodiment or at least a different embodiment which is distinguished in particular by a reduced construction space requirement and reduced losses in the magnetic flux and in particular can be produced cheaply by means of simple production.

This problem is solved according to the invention by the subject-matter of the independent claims. The dependent claims relate to advantageous embodiments.

### SUMMARY

The invention is based on the general notion of configuring an electric motor, in particular for a motor vehicle, so that, on the one hand, an armature unit of a rotor is arranged in a fluid-tight manner in a rotor receiving sleeve provided therefor and, on the other hand, permanent magnets of this armature unit which are arranged with spacing from each other in a peripheral direction at a radial outer side of a metal sheet assembly are retained at least in a peripheral direction in relation to a configuration which is optimised in terms of construction space by means of first retention devices which are constructed integrally on the metal sheet assembly in intermediate spaces of adjacent permanent magnets. To this end, the electric motor according to the invention has an internal rotor which is rotatably supported about a rotation axis relative to an external stator, wherein the rotor has a pot-like rotor receiving sleeve which is arranged around a rotor shaft for receiving the armature unit. The armature unit has a multiple-layered metal sheet assembly and a plurality of permanent magnets. The rotor receiving sleeve is closed in a fluid-tight manner with a cover in an assembled state.

Particularly advantageous is an embodiment in which the respective first retention device has two separate retention arms in the respective intermediate space, which are adjacent in the same axial plane in the peripheral direction, it being optionally possible for the two retention arms of the respective retention device to be inclined away from one another in such a way that the retention arms are at a greater distance from one another at their free ends in the peripheral direction than at their fixed ends to which they are connected to the sheet metal assembly. This simplifies the manufacture of the rotor in particular, as the separate retention arms, for example, can be plastically deformed particularly easily in order to fix the permanent magnets to the metal sheet assembly.

Another advantageous design is based on a metal sheet assembly which has several axially abutting sheets and suggests that the two retention arms of the respective retention device are formed on the same sheet metal. This simplifies the integral design of the retention arms on the respective sheet metal. For example, the sheets are punched or cut from a sheet metal web. It is advisable for several sheets to each have such integrally formed retention arms. Preferably, all or essentially all plates of the sheet pact are equipped with the retention arms integrally formed on them.

In an advantageous embodiment of the electric motor according to the invention, such a first retention device has at both sides in a peripheral direction retention arms which are constructed to be so inclined in the direction of the permanent magnets adjacent thereto in a peripheral direction that the permanent magnets are radially retained on the metal sheet assembly in a positive-locking manner. The permanent magnets which are arranged between the first retention devices on the metal sheet assembly have at the longitudinal ends thereof in a peripheral direction a complementary inclination to the inclination of the retention arms so that the permanent magnets have space in the intermediate spaces provided therefor between the first retention devices. Furthermore, the permanent magnets are formed in such a manner that the respective longitudinal ends have in a peripheral direction inclinations which hold an inclination degree which is selected in such a manner that a radially internal peripheral contour of the respective permanent magnet is greater than a radially external peripheral contour of the respective permanent magnet. That is to say that, as a result of the previously described configuration of the permanent magnets, a positive-locking connection is produced between the permanent magnets and the first retention devices which are integrally arranged on the metal sheet assembly, with the result that the permanent magnets are radially fixed to the metal sheet assembly.

In a preferred development, the metal sheet assembly of the armature unit has in the region of the first retention device, particularly preferably in the region of the retention arms, an axial recess which is constructed in a groove-like manner. The groove-like recess is advantageous when the retention arms of a first retention device are subjected, when the permanent magnets are used, to a resilient or plastic movement, as a result of a spatial displacement of the permanent magnets. The same applies in the event that the retention arms are pretensioned in the direction of the permanent magnets and, when the permanent magnets are used, are urged counter to the pretensioning.

The preferred configuration here is one in which each of the aforementioned retention arms of the respective retention device is assigned a groove-like axial recess which is located in the metal sheet assembly on one side of the respective retention arm facing the respective adjacent permanent magnet.

In another advantageous embodiment, such a retention arm of the first retention device further has at a longitudinal end facing away from the metal sheet assembly a catch projection which engages over such a permanent magnet in a peripheral direction. The catch projection surrounds the permanent magnet at least partially at the radial outer side thereof and produces in that regard a radial fixing of the permanent magnet and a fixing in a peripheral direction. It is preferable to have the combination of the first retention device with retention arms and catch projections, also pretensioned in a peripheral direction counter to the permanent magnets. The respective catch projection can be formed at the free end of the retention arm mentioned above.

According to a further embodiment, it may be provided that radially inwardly projecting projections are formed on an inner circumferential surface of an outer wall of the rotor receiving sleeve, which press at least one of the catch projections radially inward against the respective permanent magnet. In addition to an improved radial contact pressure of the permanent magnets against the metal sheet assembly, the projections also secure the fixing of the permanent magnets to the metal sheet assembly by the retention devices or their retention arms or catch projections.

A design is preferred in which a radially outer end of the respective retention device forms the radially outermost outer contour of the sheet metal assembly. This radially outer end of the respective retention device can be formed by the respective snap-in catch projection mentioned above or by the free ends of the retention arms mentioned above.

In an advantageous embodiment, the permanent magnets have at both sides in a peripheral direction at the longitudinal sides which face the first retention device, steps at which the catch projections of the first retention device engage with the permanent magnets. The advantageous aspect in this construction variant is that, in relation to the necessary construction space requirement, it is possible to have a reduction in relation to the alternative with the catch projections engaging round because the catch projections do not engage over the permanent magnets at the radial outer side thereof but instead at the step which is arranged, for example, centrally.

In an advantageous construction variant of the notion according to the invention, the cover has at an outer edge in a peripheral direction wedge-like retention elements which engage in an annular space between the permanent magnets and an outer wall of the rotor receiving sleeve and which radially wedge the permanent magnets. It is preferable in this construction variant for a wedge-like retention contour in a peripheral direction to be provided on a side of the permanent magnet opposite the cover, in the region of a base of the rotor receiving sleeve, and also to be arranged in the annular space between the permanent magnets and the outer wall of the rotor receiving sleeve so that the permanent magnets are radially wedged at both sides in a similar manner at the axial longitudinal sides.

Another construction variant makes provision for at least a second retention device to project at an inner covering surface of the outer wall of the rotor receiving sleeve and to clamp at least one of the permanent magnets radially between the metal sheet assembly and the outer wall. The rotor receiving sleeve preferably has a plurality of second retention devices so that all the permanent magnets are pressed against the metal sheet assembly at least by such a second retention device.

In a preferred embodiment, the second retention device is formed as a bead-like thickened portion and at least one such permanent magnet is pressed with such a bead-like thickened portion radially against the metal sheet assembly. Particularly preferably, such a permanent magnet is pressed against the metal sheet assembly by a plurality of such bead-like thickened portions.

Another advantageous embodiment of the above-described construction variant having a second retention device makes provision for the second retention device to be formed by two mutually facing, inclined retention arms. The retention arms of the second retention device act both radially and in a peripheral direction counter to the permanent magnets and press them radially against the metal sheet assembly in that regard and fix the permanent magnets in a peripheral direction.

Advantageously, the second retention device at least partially terminates in an inclined manner in the outer wall in the direction of an open longitudinal end of the pot-like rotor receiving sleeve. In other words, in the region of the opening of the rotor receiving sleeve the second retention device is at least partially inclined over an axial longitudinal portion so that it is possible to introduce the permanent magnets more easily.

In an advantageous embodiment, the rotor receiving sleeve is constructed as a plastics injection-moulding component. Advantageously, the cover for closing the rotor receiving sleeve is also produced as a plastics injection-moulding component. The rotor receiving sleeve is preferably injection-moulded directly on the rotor shaft or directly on a bearing bush which is formed to receive such a rotor shaft.

In an advantageous development, the rotor receiving sleeve has at the inner wall thereof at a side facing the opening an annular step which forms a recess which is open with respect to the cover and the rotor shaft or the bearing bush. That recess prevents the cover from bonding with the rotor shaft or the bearing bush during a production process. Furthermore, the recess may act as a collection space for excess material from the production process.

In an advantageous embodiment, the cover for the rotor receiving sleeve is arranged to be radially spaced apart from the rotor shaft or the bearing bush. The radial spacing is advantageous in that during a production process in which the cover is fitted to the rotor receiving sleeve subsequently, an axially free movement to connect the two components to each other makes the production step easier. The rotor receiving sleeve has at a side facing the cover, at the inner wall thereof and the outer wall thereof a tapering collar which is formed so that a subsequent production step is positively influenced by the shape. For example, during ultrasonic welding, an improved energy introduction into the locations to be welded is provided by the tapering collar.

Advantageously, the cover is provided for the fluid-tight closure of an armature receiving space which is arranged in the rotor receiving sleeve. The cover is preferably securely welded to the rotor receiving sleeve by means of an ultrasonic welding method. In the context of the invention, it is also conceivable for the cover with the rotor receiving member to be fitted by a rotational friction welding method or a laser welding method. It is further possible to injection-mould the cover on the rotor receiving sleeve accordingly.

Particularly advantageous is a configuration in which the cover is designed as a pump running wheel for pumping a liquid. This makes it particularly easy to use the electric motor presented here to produce a compact liquid pump.

In a method according to the invention for producing a previously described electric motor, the metal sheet assembly is introduced or inserted in an axial direction into the armature receiving space of the rotor receiving sleeve. Subsequently, at least one such permanent magnet is introduced in an axial direction into the region between the first retention devices of the metal sheet assembly and the outer wall of the rotor receiving sleeve. Finally, the rotor receiving sleeve is closed by welding or injection-moulding the cover in a fluid-tight manner.

In another method according to the invention for producing a previously described electric motor, in particular for an electric fluid pump, there may be added to the above-described method an additional method step which involves welding a separate pump running wheel with respect to the cover to the rotor receiving sleeve by means of ultrasonic welding or laser beam welding. In this case, the rotor receiving sleeve forms a hermetic enclosure which surrounds the armature unit and which also relates to both the rotor receiving sleeve and the cover. A preferred configuration here is also a variant in which the cover itself forms the pump running wheel or is designed as a pump running wheel.

An electric machine according to the invention has at least one such electric motor which is constructed or configured according to the above-described manner.

An electric fluid pump for pumping a liquid has a pump running wheel which, when rotating, pumps the liquid and an electric motor of the type described above which is drive-connected to the pump running wheel for rotating the pump running wheel. For this purpose, the pump running wheel can be connected directly to the rotor in a rotationally fixed manner. In particular, according to a first variant, the pump running wheel can be designed separately from the cover and connected directly to the rotor in a rotationally fixed manner, in particular welded to the rotor by means of ultrasonic welding. Alternatively, according to a second variant, the cover can be designed as a pump running wheel and directly connected to the rotor in a rotationally fixed manner, in particular welded to the rotor by ultrasonic welding. At these embodiments thus the pump running wheel will turn resp. rotate synchronous with rotor around its turning axis.

Additional important features and advantages of the invention will be appreciated from the dependent claims, the drawings and the associated description of the Figures with reference to the drawings.

It will be understood that the above-mentioned features and those which will be explained below may be used not only in the combination set out but also in other combinations or alone, without departing from the scope of the present invention.

Preferred embodiments of the invention are illustrated in the drawings and are explained in greater detail in the following description, wherein the same reference numerals refer to the same or similar or functionally identical components.

### BRIEF DESCRIPTION OF THE DRAWINGS

In the schematic drawings:

FIG. 1 is an isometric illustration of an enclosed rotor which is arranged on a rotor shaft in the form of a hollow shaft,

FIG. 2 is a cross-section of an electric motor having an internal rotor and an external stator,

FIG. 3 is a longitudinal section from FIG. 1 with a rotor receiving sleeve which is arranged on a rotor shaft,

FIG. 4 is a detailed view IV from FIG. 3 in the region of a cover which closes a rotor receiving sleeve,

FIG. 5 is a cross-section of the rotor from FIG. 3 through the section V-V,

FIG. 6 is a detailed view VI from FIG. 5 in the region of a metal sheet assembly and permanent magnets arranged thereon by means of a first retention device,

FIG. 7 is the view from FIG. 6 in an advantageous construction variant with a different first retention device,

FIG. 8 is a detailed view VIII from FIG. 7 in the region of the first retention device,

FIG. 9 is the view from FIGS. 6 and 7 in another advantageous construction variant with step-like permanent magnets and a different first retention device,

FIG. 10 is an isometric illustration of a rotor receiving sleeve,

FIG. 11 is a detailed view of an advantageous construction variant with a different second retention device,

FIG. 12 is an isometric illustration of a construction variant of a cover for closing a rotor receiving sleeve with wedge-like retention elements,

FIG. 13 is a longitudinal section of a construction variant of a rotor receiving sleeve with a cover positioned thereon from FIG. 12,

FIG. 14 a detailed view as in FIG. 8, but with a different embodiment,

FIG. 15 a longitudinal section as in FIG. 13, but with a different embodiment.

### DETAILED DESCRIPTION

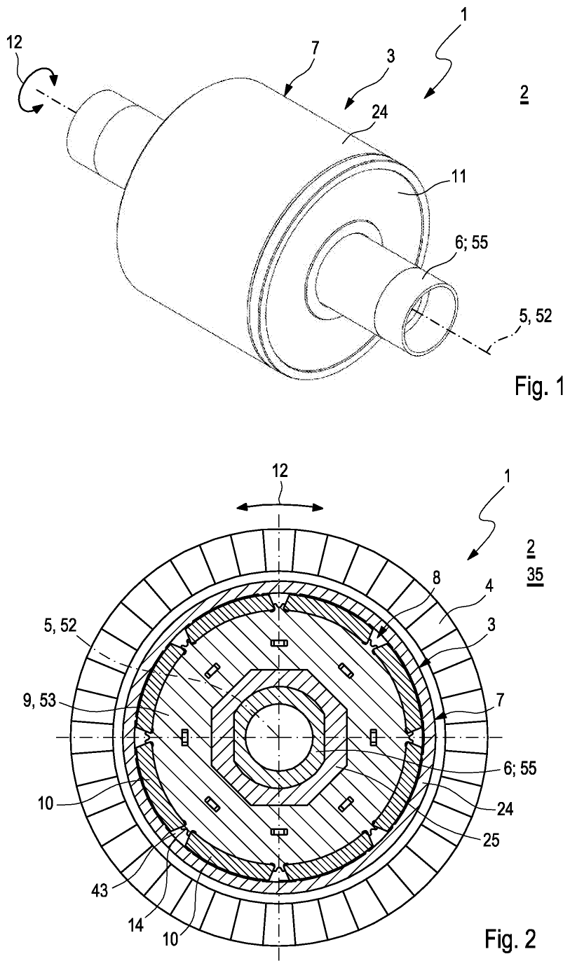

FIG. 1 is an isometric illustration of an internal rotor 3 of an electric motor 1 according to the invention which is arranged on a rotor shaft 6 in the form of a hollow shaft. The rotor 3 is supported rotatably about a rotation axis 5 relative to an external stator 4 in a peripheral direction 12. The rotor shaft 6 is operatively connected to the rotor 3 per se. A rotor receiving sleeve 7 at least partially surrounds the rotor shaft 6 over an axial longitudinal portion. In place of the rotor shaft 6, it is also conceivable for a bearing bush 55 for receiving such a rotor shaft 6 to be injection-moulded by a rotor receiving sleeve 7. Subsequently, such a bearing bush 55 may be used in place of the rotor shaft 6.

In this context, the axis of rotation 5 defines the longitudinal axis 52 of the rotor 3, which therefore extends parallel to the axis of rotation 5. The radial direction is generally perpendicular to the longitudinal axis and only in particular perpendicular to the rotational axis 5. The peripheral direction, indicated in some of the figures by a double arrow and marked 12, rotates around the rotational axis 5.

FIG. 2 is a cross-section of an electric motor 1 according to the invention, in particular for a motor vehicle 2, having an internal rotor 3 and an external stator 4, wherein the stator 4 is fixedly supported and the rotor 3 is rotatably supported in the peripheral direction 12 about the rotation axis 5 on the rotor shaft 6. Furthermore, the schematically shown electric motor 1 may be a component of an electric machine 35 which is further not shown.

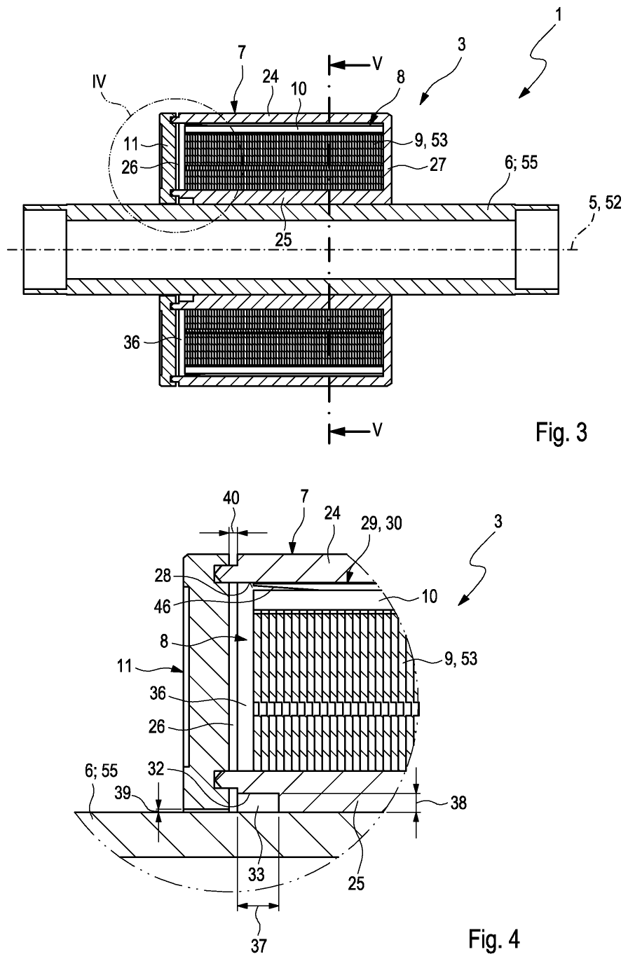

FIG. 3 is a longitudinal section from FIG. 1 with a rotor receiving sleeve 7 which is arranged on a rotor shaft 6. The rotor receiving sleeve 7 is formed in a pot-like manner and has an inner wall 25 which is in direct contact with the rotor shaft 6. A longitudinal end of the rotor receiving sleeve 7 is closed with a base 27. The base 27 connects the inner wall 25 to an outer wall 24 of the rotor receiving sleeve 7. In particular, the base 27 can be made in one piece with inner wall 25 and outer wall 24, e.g. by injection moulding. A different longitudinal end of the rotor receiving sleeve 7 has an annular opening 26 which is provided to insert an armature unit 8. The opening 26 of the rotor receiving sleeve 7 may be closed in a fluid-tight manner with a cover 11 after insertion of the armature unit 8. The rotor receiving sleeve 7 surrounds an armature receiving space 36 which is provided for the armature unit 8.

FIG. 4 is a detailed view IV from FIG. 3 in the region of a cover 11 which closes a rotor receiving sleeve 7. The inner wall 25 of the rotor receiving sleeve 7 has at a side facing the opening 26 an annular step 32. An open recess 33 which is produced by the annular step 32 may extend in a longitudinally axial direction over a longitudinal portion 37. A first radial gap 38 of the annular step 32 or the recess 33 may extend in a radial direction over, for example, half of the material thickness of the inner wall 25 of the rotor receiving sleeve 7. The cover 11 is also arranged radially with spacing from the rotor shaft 6 by a second radial gap 39. Furthermore, the cover 11 may additionally have an axial play 40 in the direction of the cover 11 at the inner wall 25 and the outer wall 24 of the rotor receiving sleeve 7.

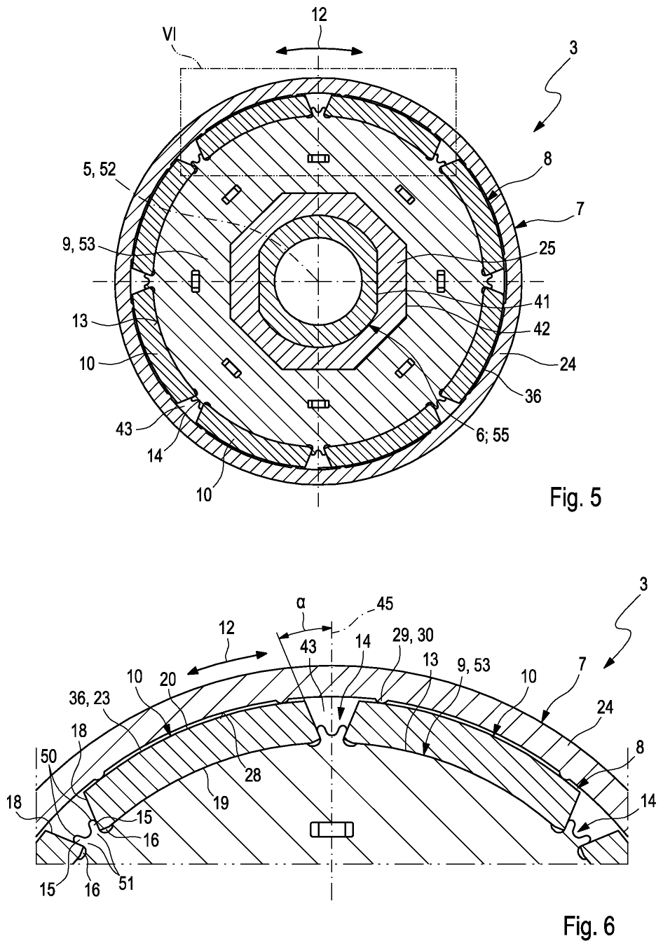

FIG. 5 is a cross-section of the rotor 3 from FIG. 3 through the section V-V. The rotor shaft 6 may have at least one notch 41 at an otherwise cylindrical outer covering surface in order to achieve a positive-locking connection to the rotor receiving sleeve 7. As a result of the rotor receiving sleeve 7 being injection-moulded on the rotor shaft 6, the rotor shaft 6 is completely in a peripheral direction 12 in direct and positive-locking contact with the inner wall 25 of the rotor receiving sleeve 7. The positive-locking connection between the rotor shaft 6 and the rotor receiving sleeve 7 serves to transmit torque, wherein any configuration for positive-locking or frictionally engaging torque transmission is protected within the scope of the invention. The inner wall 25 of the rotor receiving sleeve 7 may be formed as a polygon 42 in the cross-sectional profile at a side facing the outer wall 24 of the rotor receiving sleeve 7. A subsequently inserted metal sheet assembly 9 has a contour which is constructed to complement the polygon 42 so that a positive-locking connection between the metal sheet assembly 9 and the rotor receiving sleeve 7 is also produced here. The metal sheet assembly 9 which can subsequently be inserted into the rotor receiving sleeve 7 forms together with permanent magnets 10 which are arranged at a radial outer side 13 of the metal sheet assembly 9, an armature unit 8. In the exemplary embodiment illustrated, the armature unit 8 has a total of eight permanent magnets 10 which are retained with a first retention device 14 which are arranged integrally on the metal sheet assembly 9 in an intermediate space 43 between adjacent permanent magnets 10. Consequently, the permanent magnets 10 are arranged radially between the metal sheet assembly 9 and the outer wall 24 of the rotor receiving sleeve 7. The metal sheet assembly 9 usually consists of a large number of separate sheets 53 which lie on top of each other in the axial direction 52. Identical sheets 53 are used for this purpose. They can lie loosely against each other and be axially braced together with corresponding anchors. In principle, they can also be glued or soldered together.

FIG. 6 is a detailed view VI of the rotor 3 from FIG. 5 in the region of a metal sheet assembly 9 and permanent magnets 10 arranged thereon by means of the first retention device 14. The respective retention device 14 has two separate retention arms 15 within the same axial plane, which is represented here by the sectional plane of FIG. 6. In the preferred example, the two retention arms 15 of the respective retention device 14 are inclined away from each other. This inclination is selected so that the retention arms 15 have a greater distance in the peripheral direction 12 at their radially outer free ends 50 than at their radially inner fixed ends 51 to which they are connected with the metal sheet assembly 9. Furthermore, it is provided here that the two retention arms 15 of the respective retention device 14 are formed on the same sheet metal 53. Almost every or every sheet metal 53 is equipped with these retention arms 15. Accordingly, the first retention device 14 may have adjacent in the peripheral direction 12, i.e. have these separate retention arms 15 on both sides, which are inclined in the direction of the permanent magnets 10 adjacent in the peripheral direction 12 in such a way that that the permanent magnets 10 are retained in a positive-locking manner radially on the metal sheet assembly 9. The retention arms 15 each have to this end an inclination angle α which is defined by means of a plane of symmetry 45 of the first retention device 14 and the orientation of the retention arms 15 in a peripheral direction 12. This inclination angle α substantially also describes a degree of inclination of inclinations 18 which are correspondingly formed at the respective longitudinal ends in a peripheral direction 12 of the permanent magnets 10. The inclinations 18 at the longitudinal ends of the permanent magnets 10 can consequently be formed so as to complement the inclination angle α of the retention arms 15 of the first retention device 14. The first retention device 14 or the two-sided retention arms 15 may retain the permanent magnets 10 radially in a fixed position depending on the configuration of the inclination angle α and the degree of inclination of the inclinations 18 of the permanent magnets 10. Furthermore, the degree of inclination of the inclinations 18 may be selected so that a radially internal peripheral contour 19 of the respective permanent magnets 10 is greater than a radially external peripheral contour 20 of the respective permanent magnets 10, wherein the degree of inclination of the inclinations 18 is intended to correspond to the inclination angle α of the retention arms 15 of the first retention device 14. The metal sheet assembly 9 may have in the region of the first retention device 14, in particular in the region of the retention arms 15, longitudinally axial recesses 16 which may be constructed in a groove-like manner. These recesses 16 can be clearly located on each of the holding arms 15, on one side facing the adjacent permanent magnet 10.

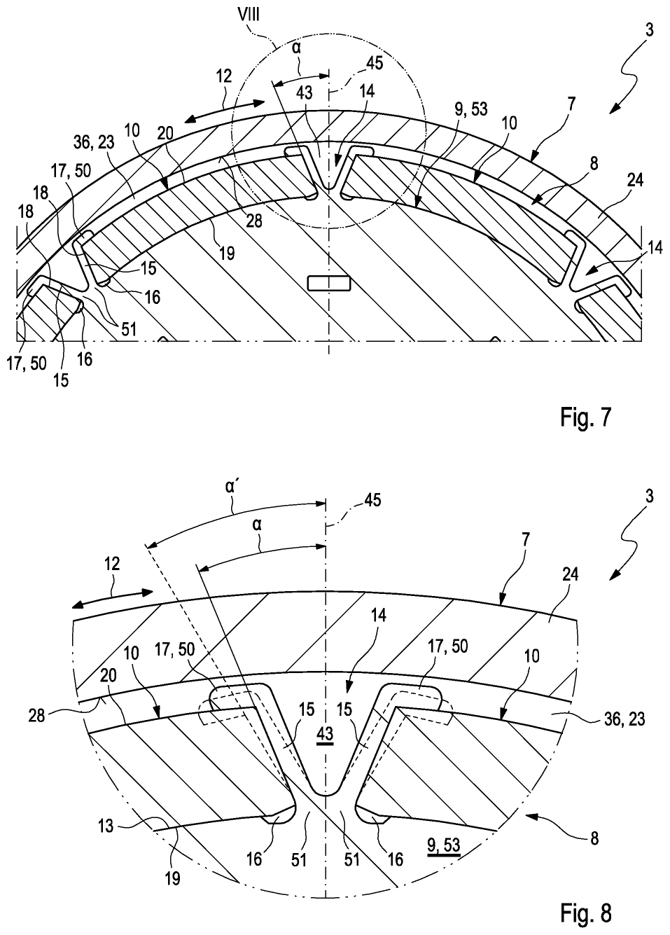

FIG. 7 is the detailed view from FIG. 6 in an advantageous construction variant with a different first retention device 14. Such a retention arm 15 of the first retention device 14 may have at a longitudinal end facing away from the metal sheet assembly 9 a catch projection 17 which engages over such a permanent magnet 10 in a peripheral direction 12, respectively. Such a catch projection 17 may at least partially surround the permanent magnet 10 at the radial outer side 13 thereof and in this respect produces a radial fixing of the permanent magnet 10 and a fixing in a peripheral direction 12. Advantageously, as shown by way of example in the construction variant, all the retention arms 15 of the first retention device 14 may be provided with the described catch projections 17.

FIG. 8 is a detailed view VIII from FIG. 7 in the region of a first retention device 14, in which a resilient or plastic movement of the retention arms 15 is indicated. In a first state, before insertion of the permanent magnets 10 in the region provided therefor between the retention arms 15 of the first retention device 14, the retention arms 15 have an inclination angle α′ which is at least greater than an inclination angle α in a second state, after insertion of the permanent magnets 10 in the region between the retention arms 15. The greater inclination angle α′ in the first state is based on a pretensioning of the retention arms 15 of the first retention device 14 in a peripheral direction 12 counter to the permanent magnets 10.

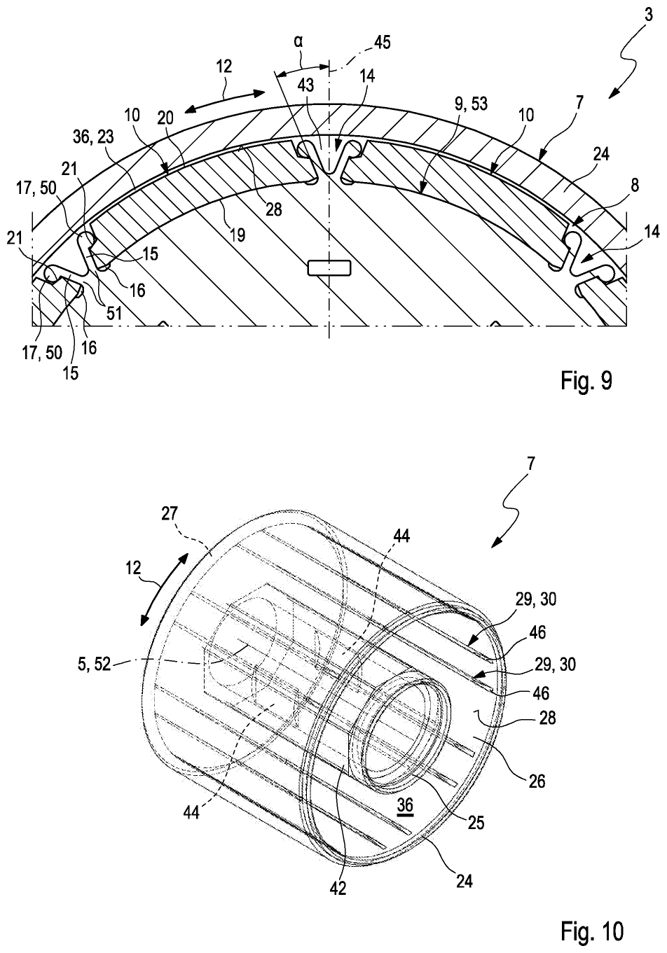

FIG. 9 is the view from FIG. 6 and FIG. 7 in another advantageous construction variant with step-like permanent magnets 10 and a different first retention device 14. The permanent magnets 10 have at both sides in a peripheral direction 12, at the longitudinal sides facing the first retention device 14 or the retention arms 15, steps 21 at which rounded catch projections 17 of the first retention device 14 engage with the permanent magnets 10. The steps 21 on the permanent magnets 10 may, for example, be arranged centrally at the longitudinal sides in a peripheral direction 12. The retention arms 15 of the first retention device 14 accordingly extend radially only over half of the radial width of the permanent magnets 10. There may be arranged at a longitudinal side of the retention arms 15 facing away from the metal sheet assembly 9 the catch projections 17 which partially engage over the permanent magnets 10 in a peripheral direction 12 and consequently retain both in a peripheral direction 12 and radially.

FIG. 10 is an isometric illustration of the rotor receiving sleeve 7 with an arranged second retention device 29. The second retention device 29 may be constructed as a bead-like thickened portion 30 which projects at an inner covering surface 28 of the outer wall 24 of the rotor receiving sleeve 7. The second retention device 29 which is constructed as a bead-like thickened portion 30 in this depiction may at least partially have a tapered portion 46, which terminates in the outer wall 24 of the rotor receiving sleeve 7, over an axial longitudinal portion at a side facing the opening 26. Furthermore, a negative formation 44 with respect to the notch 41 of the rotor shaft 6 can be seen in the depiction. The two negative formations 44 arranged by way of example in the construction variant constitute the region, in particular on plastics material, which can also be injection-moulded in the region of the notches 41 of the rotor shaft 6 in addition.

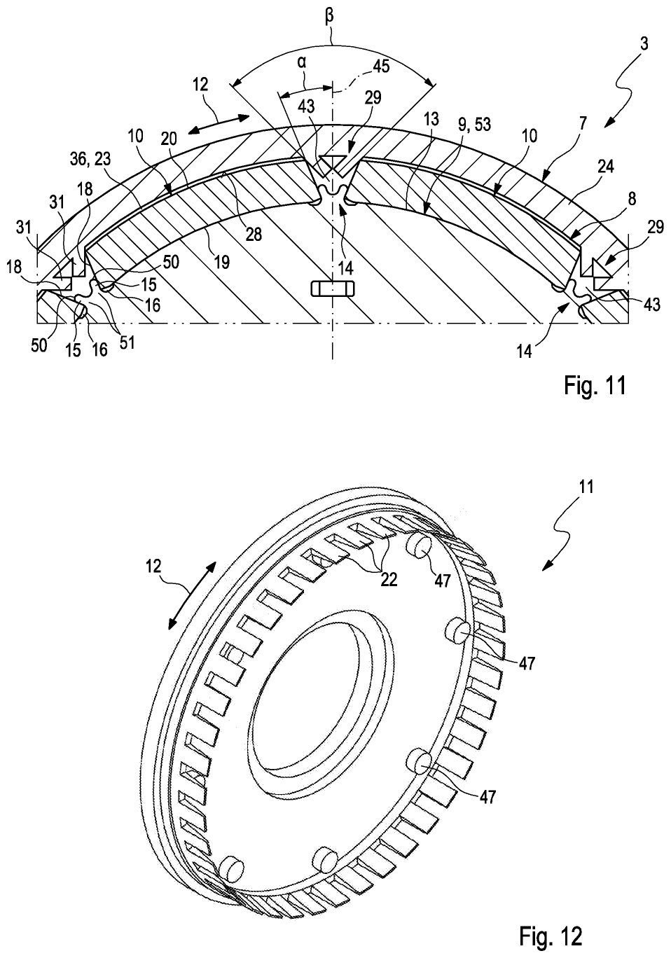

FIG. 11 is a detailed view of an advantageous construction variant of the rotor receiving sleeve 7 with a different second retention device 29. The second retention device 29 shown has two mutually facing, inclined retention arms 31 which are in contact with the permanent magnets 10 and radially clamp them. The retention arms 31 of the second retention device 29 are at an angle β to each other which is intended to be at least greater than 0° and less than 180°. The retention arms 30 of the second retention device 29 extend at the maximum over a length which is selected so that at least a defined spacing of the retention arms 30 of the second retention device 29 is provided. The first retention device 14 and the second retention device 29 are not connected to each other in the embodiment shown. Direct contact between the first retention device 14 and the second retention device 29, in particular a cooperation of the two retention devices 14, 29 for radially fixing the permanent magnets 10, is conceivable within the context of this invention.

FIG. 12 is an isometric illustration of a construction variant of a cover 11 which is constructed for closing a rotor receiving sleeve 7 with wedge-like retention elements 22. To this end, the cover 11 may have at an outer edge in a peripheral direction 12 distributed such wedge-like retention elements 22 which, when the cover 11 is placed on the rotor receiving sleeve 7, thus project axially in the direction of that rotor receiving sleeve 7. The wedge-like retention elements 22 taper in the direction of the rotor receiving sleeve 7. Furthermore, cylindrically formed spacers 47 may be arranged on the cover 11 in a peripheral direction 12 and project in the same direction as the wedge-like retention elements 22. The spacers 47 can press the armature unit 8 axially into the rotor receiving sleeve 7 or radially clamp the armature unit 8 by means of the axial pressure to the base 27 of the rotor receiving sleeve 7 by means of a wedge-like retention contour 48 which will be explained in greater detail below.

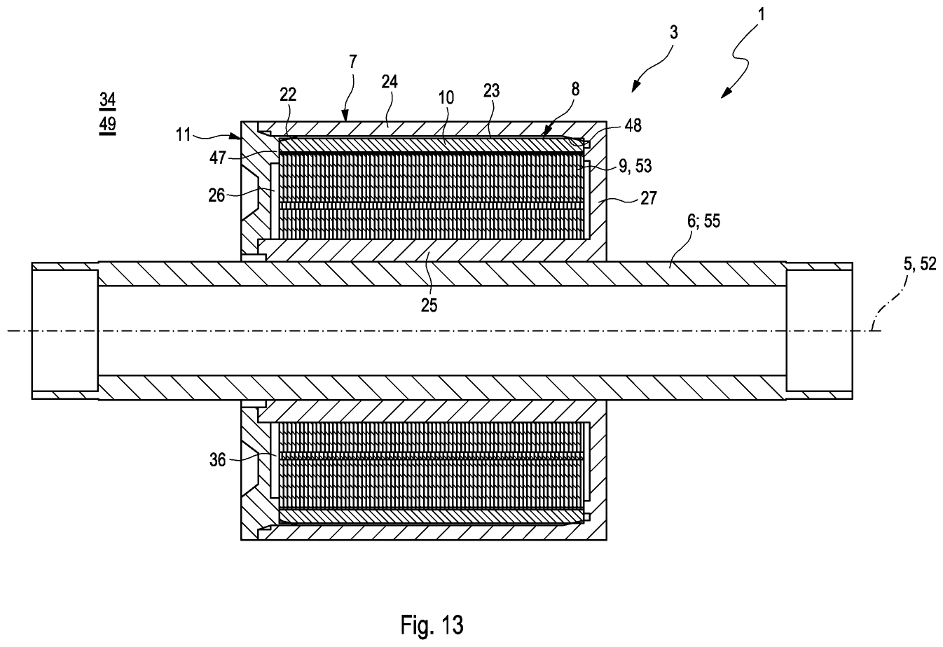

FIG. 13 is a longitudinal section of a construction variant of a rotor receiving sleeve 7, with a cover 11 positioned thereon from FIG. 12, which is injection-moulded on a rotor shaft 6. The rotor receiving sleeve 7 may have in the region of the base 27 at an outer wall 24 a wedge-like retention contour 48 which tapers in the direction of the opening 26 of the rotor receiving sleeve 7. An inserted armature unit 8 which comprises an annular metal sheet assembly 9 and a plurality of permanent magnets 10 can be inserted axially into the rotor receiving sleeve 7, wherein the permanent magnets 10 are in contact with the wedge-like retention contour 48 and are wedged therewith. The previously described cover 11 with arranged wedge-like retention elements 22 wedges the armature unit 8, in particular the permanent magnets 10, at the side of the opening 26 of the rotor receiving sleeve 7. The wedge-like retention elements 22 on the cover 11 and the wedge-like retention contour 48 on the base 27 of the rotor receiving sleeve 7 are both in a radial region between the permanent magnets 10 and the outer wall 24 of the rotor receiving sleeve 7 which may also be referred to as an annular space 23.

A in FIG. 13 shown pump running wheel 49 which is not further shown may subsequently be fitted to the rotor receiving sleeve 7 or be connected securely to the rotor receiving sleeve 7. The electric motor 1 per se forms with a fitted pump running wheel 49 an electric fluid pump 34 according to the invention.

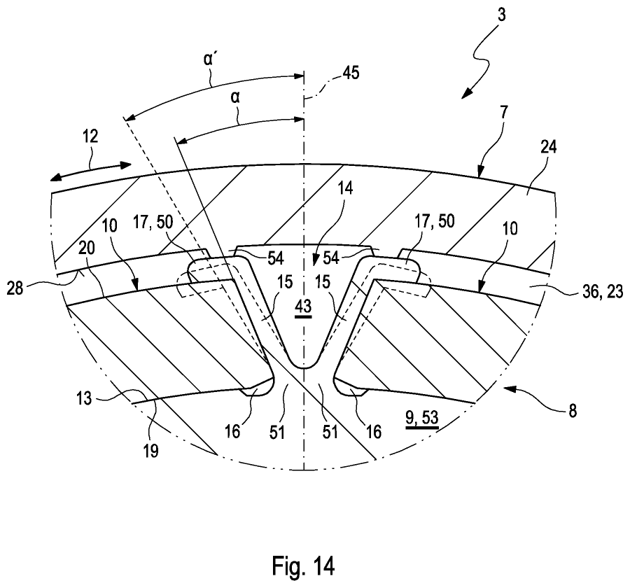

In the embodiment shown in FIG. 14, which can otherwise correspond to the embodiment shown in FIG. 8, there are radially inwardly projecting projections 54 on the inner surface 28 of the outer wall 24 of the rotor receiving sleeve 7. Preferably, these projections 54 are integrally formed on said outer wall 24. These projections 54, which can extend in particular over the entire metal sheet assembly 9, press at least one of the catch projections 17 radially inwards against the respective permanent magnet 10. In the example shown, a separate projection 54 is assigned to each support arm 15 or each catch projection 17. In another embodiment not shown here, a common projection 54 can also be provided, which is assigned to both retention arms 15 or the two associated catch projections 17 of the respective retention device 14 and presses these together against the two adjacent permanent magnets 10.

In all of the designs shown here, it may be provided that a radially outer end of the respective retention device 14 forms the radially outermost outer contour of the sheet metal assembly 9. The radially outer end of the respective retention device 14 is formed here by the free ends 50 of the retention arms 15 or by the catch projections 17.

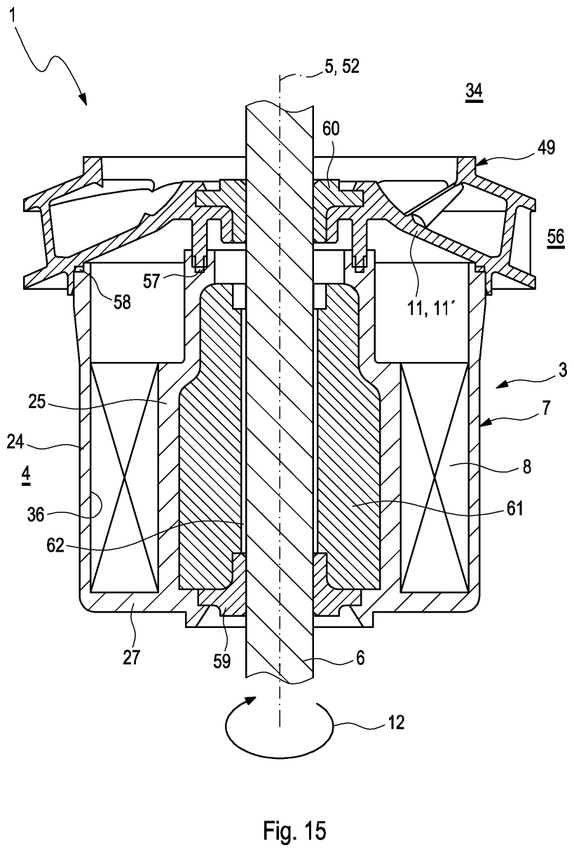

While FIG. 13 indicates a design in which a separate pump running wheel 49 is fixed to the rotor 3 in a rotationally fixed manner, FIG. 15 shows an embodiment in which the cover 11 itself forms the pump running wheel 49 or in which the cover 11 is designed as a pump running wheel 49.

The rotor receiving sleeve 7 contains a receiving space 36 to receive the armature unit 8. This receiving space 36 is expediently open on an axial side facing the pump running wheel 49, so that the armature unit 8 can be inserted axially into the rotor receiving sleeve 7 on this axial side. For sealing against the pumped liquid 56, the receiving chamber 36 is closed when the rotor 3 is assembled. A separate cover 11 can be used for this purpose, which is a separate component in the design shown in FIG. 13 with respect to the pump running wheel 49 and with respect to the remaining rotor receiving sleeve 7. In principle, the pump running wheel 49 can be connected directly to the separate cover 11, which in turn is connected to the rotor mounting sleeve 7.

FIG. 15 now shows another embodiment in which the cover 11 is designed as a pump running wheel 49 for pumping a liquid. For this purpose the pump running wheel 49 and the cover 11 can be designed in one piece. In other words, in this case the cover 11 is integrally formed on the pump running wheel 49. This also means that the pump running wheel 49 forms the cover 11 as an additional function at the same time. As a result, the pump running wheel 49 has a cover section of 11′. In FIG. 15 the pump running wheel 49 or its cover section 11′ closes the receiving space 36 of the rotor receiving sleeve 7.

According to FIGS. 3, 13 and 15, the receiving chamber 36 is ring-shaped and radially delimited inside by the preferably cylindrical inner wall 25 and radially outside by the preferably cylindrical outer wall 24. This means that the armature unit 8 has no contact with the rotor shaft 6.

Preferably, the rotor receiving sleeve 7 has the base 27 at its axial end remote from the pump running wheel 49, which connects the inner wall 25 with the outer wall 24. This means that the receiving chamber 36 is open on the axial side facing the pump running wheel 49, so that the armature unit 8 can be used on this axial side. It may also be preferred that the inner wall 25, the outer wall 24 and the floor 27 are manufactured in one piece, e.g. as an injection-moulded part, and form a monolithic body.

According to FIG. 15, the pump running wheel 49 forming the cover 11 or having the cover section 11′ can be fixed to the inner wall 25 with an inner welded joint 57 and to the outer wall 24 with an outer welded joint 58. The outer weld 58 seals the receiving chamber 36 to the outside against the liquid 56 surrounding the rotor 3. The inner welded joint 57 also seals the receiving space 36 to the outside against the liquid 56, which can enter the space enclosed by the inner wall 25 along the rotor shaft 6 past bearing sleeves 59, 60.

According to the embodiment of FIG. 15 shown here, the two axially spaced bearing sleeves 59, 60 can be provided for improved integration of the rotor shaft 6 into the rotor 3. The two bearing sleeves 59, 60 are designed and matched to the rotor shaft 6 and any existing bearing bush 61 in such a way that an annular space 62 is formed radially between the bearing bush 61 and the rotor shaft 6.

In the example of FIG. 15, one bearing sleeve 59 is arranged on the bearing sleeve 61 at a longitudinal end of the bearing sleeve 61 remote from the pump running wheel 49, while the other bearing sleeve 60 is arranged axially from the bearing sleeve 61 in or on the pump running wheel 49. This allows the axial length of the rotor 3 with pump running wheel 49 to be reduced.

1. An electric motor, comprising:
an internal rotor arranged rotatably supported about a rotation axis relative to an external stator;
the internal rotor including a pot-shaped rotor receiving sleeve arranged around a rotor shaft and an armature unit received in the rotor receiving sleeve, the armature unit including a multiple-layered metal sheet assembly and a plurality of permanent magnets;
a cover that closes the rotor receiving sleeve in a fluid-tight manner;
wherein the plurality of permanent magnets are arranged with spacing from each other in a peripheral direction at a radial outer side of the metal sheet assembly; and
wherein the metal sheet assembly includes at least one retention device disposed integrally thereon in an intermediate spaces between adjacent permanent magnets, structured and arranged to reduce slippage in the peripheral direction.

2. The electric motor according to claim 1,
wherein the at least one retention device has, in the intermediate space, two separate retention arms arranged adjacent in a common axial plane in the peripheral direction; and
wherein the two retention arms are inclined away from one another, so that the two retention arms have a greater distance at respective free ends in the peripheral direction than at respective fixed ends connected to the metal sheet assembly.

3. The electric motor according to claim 2, wherein:
the metal sheet assembly has a plurality of axially abutting sheets; and
the two retention arms are disposed on a common sheet of the plurality of sheets.

4. The electric motor according to claim 1, wherein the at least one retention device has retention arms at both sides thereof in the peripheral direction that are inclined in a direction of the permanent magnets adjacent thereto in the peripheral direction such that the permanent magnets are radially retained on the metal sheet assembly in a positive-locking manner.

5. The electric motor according to claim 1, wherein the metal sheet assembly has a groove-shaped axial recess in a region of the at least one retention device.

6. The electric motor according to claim 2, wherein each retention arm is provided a respective groove-shaped axial recess disposed in the metal sheet assembly on a side of the respective retention arm facing an adjacent permanent magnet.

7. The electric motor according to claim 1, wherein the at least one retention device has a retention arm including a catch projection disposed at the longitudinal end thereof that engages over a respective permanent magnet in the peripheral direction.

8. The electric motor according to claim 7, further comprising a plurality of radially inwardly projecting projections disposed on an inner circumferential surface of an outer wall of the rotor receiving sleeve, wherein the plurality of radially inwardly projecting projections press the catch projection radially inwardly against the respective permanent magnet.

9. The electric motor according to claim 1, wherein a radially outer end of the at least one retention device defines a radially outermost outer contour of the metal sheet assembly.

10. The electric motor according to claim 1, wherein:
the plurality of permanent magnets are structured and arranged such that respective longitudinal ends thereof have inclinations in the peripheral direction, and
a degree of inclination of the inclinations is such that a radially internal peripheral contour of a respective permanent magnet is greater than a radially external peripheral contour of the respective permanent magnet.

11. The electric motor according to claim 14, wherein the adjacent permanent magnets each have a step at a respective longitudinal side that faces the at least one retention device, and wherein the at least one retention device interacts with the adjacent permanent magnets via the step.

12. The electric motor according to claim 1, wherein the at least one retention device includes retention arms that are pretensioned in the peripheral direction counter to the adjacent permanent magnets.

13. The electric motor according to claim 1, wherein:
an annular space is disposed radially between the plurality of permanent magnets and an outer wall of the rotor receiving sleeve, and
the cover has a plurality of wedge-shaped retention elements disposed at an outer edge of the cover that are distributed in the peripheral direction and engage into the annular space so as to radially wedge the plurality of permanent magnets.

14. The electric motor according to claim 1, wherein:
an annular space is disposed radially between the plurality of permanent magnets and an outer wall of the rotor receiving sleeve, and
the rotor receiving sleeve has, in a region of a base at an inner covering surface of the outer wall, an axial projection into the annular space a circumferential wedge-like retention contour in the peripheral direction that radially wedges against the plurality of permanent magnets.

15. The electric motor according to claim 1, wherein an annular space is disposed radially between the plurality of permanent magnets and an outer wall of the rotor receiving sleeve, and
further including at least one second retention device that projects radially into the annular space at an inner covering surface of the outer wall of the rotor receiving sleeve and clamps at least one of the plurality of permanent magnets radially between the metal sheet assembly and the outer wall of the rotor receiving sleeve.

16. The electric motor according to claim 15, wherein the at least one second retention device comprises a bead-like thickened portion, and the at least one section retention device is structured and arranged such that the at least one of the plurality of permanent magnets is pressed with the bead-like thickened portion radially against the metal sheet assembly.

17. The electric motor according to claim 15, wherein the at least one second retention device has two mutually facing, inclined retention arms that are pretensioned and act both radially and in the peripheral direction counter to the plurality of permanent magnets.

18. The electric motor according to claim 15, wherein the at least one second retention device at least partially terminates in an inclined manner at an outer wall in a direction of an opening of the rotor receiving sleeve.

19. The electric motor according to claim 1, wherein at least one of the rotor receiving sleeve and the cover is a plastic injection-moulding component.

20. The electric motor according to claim 1, wherein the rotor receiving sleeve is injection-moulded directly on the rotor shaft or injection-moulded on a bearing bush that receives the rotor shaft.

21. The electric motor according to claim 1, wherein the rotor receiving sleeve has an inner wall including an annular step at a side of the inner wall facing an opening of the rotor receiving sleeve, the annular step structured and arranged to provide a recess that is open with respect to the cover and the rotor shaft.

22. The electric motor according to claim 1, wherein at least one of an inner wall and/or the outer wall of the rotor receiving sleeve tapers in an acute manner at a side facing the cover.

23. The electric motor according to claim 1, wherein the cover for the rotor receiving sleeve is arranged radially spaced apart from the rotor shaft or a bearing bush arranged thereon.

24. The electric motor according to claim 1, wherein the cover provides a fluid-tight closure of an armature receiving space in the rotor receiving space and the cover is welded to the rotor receiving sleeve.

25. The electric motor according to claim 1, wherein the cover is structured as a pump running wheel for conveying a liquid.

26. A method for producing an electric motor, comprising:
providing a pot-shaped rotor receiving sleeve;
inserting a multiple-layered metal sheet assembly in an axial direction into an armature receiving space of the rotor receiving sleeve, the metal sheet assembly having a plurality of retention devices at an outer side thereof disposed spaced apart in a peripheral direction;
inserting a plurality of permanent magnets in the axial direction into a region between the first plurality of retention devices of the metal sheet assembly and an outer wall of the rotor receiving sleeve; and
closing the rotor receiving sleeve by welding or injection-moulding a cover to the rotor receiving sleeve.

27. (canceled)

28. Method according to claim 26, further comprising welding a pump running wheel to the rotor receiving sleeve via ultrasonic welding or laser beam welding.

29. An electric machine, comprising the electric motor as claimed according to claim 1.

30. A liquid pump, comprising:
a pump running wheel structured and arranged to convey a liquid when rotated;
an electric motor for rotatably driving the pump running wheel, the electric motor including:
an external stator;
an internal rotor arranged rotatably supported about a rotation axis relative to the external stator, the internal rotor including a pot-shaped rotor receiving sleeve arranged around a rotor shaft and an armature unit received in the rotor receiving sleeve, the armature unit including a multiple-layered metal sheet assembly and a plurality of permanent magnets;
a cover that closes the rotor receiving sleeve in a fluid-tight manner;
wherein the plurality of permanent magnets are arranged with spacing from each other in a peripheral direction at a radial outer side of the metal sheet assembly; and
wherein the metal sheet assembly includes a plurality of retention devices disposed on the radial outer side and respectively arranged in a corresponding intermediate space in the peripheral direction between adjacent permanent magnets of the plurality of permanent magnets to reduce slippage of the plurality of magnets in the peripheral direction.

31. The liquid pump according to claim 30, wherein:
the pump running wheel is arranged separately from the cover and is directly connected to the internal rotor in a rotationally fixed manner, or
the cover is disposed integrally on the pump running wheel and is connected directly to the inner rotor in a rotationally fixed manner.
